(19) United States
(12) Patent Application Publication
(10) Pub. No.: US 2025/0391894 A1
(43) Pub. Date: Dec. 25, 2025

(54) METHOD AND CONTROL UNIT FOR DETERMINING THE HYDROGEN PROPORTION IN THE EXHAUST GAS STREAM OF A HYDROGEN-POWERED ASSEMBLY

(71) Applicant: Robert Bosch GmbH, Stuttgart (DE)

(72) Inventors: Lyu Zhang, Ditzingen (DE); Sven Faehnle, Sachsenheim (DE)

(21) Appl. No.: 19/243,845

(22) Filed: Jun. 20, 2025

(30) Foreign Application Priority Data
Jun. 20, 2024 (DE) 10 2024 205 739.8

(51) Int. Cl. H01M 8/04992; H01M 8/0432; H01M 8/0438; H01M 8/0444; H01M 8/04746

(52) U.S. Cl. CPC H01M 8/04992; H01M 8/04335; H01M 8/0435; H01M 8/0441; H01M 8/04455; H01M 8/0447; H01M 8/04753

(57) ABSTRACT

A computer-implemented method, for determining a hydrogen proportion in an exhaust gas stream of a hydrogen powered assembly configured so as to convert hydrogen and oxygen into water, wherein a balance sheet model is used to determine the hydrogen proportion by modeling the conversion of hydrogen and oxygen into water and using this as a basis for balancing hydrogen, oxygen, and water in an input hydrogen stream, an input oxygen stream, and in the exhaust gas stream of the assembly. In one example, the method includes deriving the hydrogen proportion in the exhaust gas stream via the balance sheet model from the input hydrogen stream of the assembly, the input oxygen stream of the assembly, and an oxygen proportion in the exhaust gas stream or an exhaust gas lambda value of the exhaust gas stream.

### BACKGROUND

The invention relates to a method for determining a hydrogen proportion in an exhaust gas stream of a hydrogen-powered assembly. Moreover, the invention relates to a control unit for a hydrogen-powered assembly, wherein the control unit is configured so as to determine a hydrogen proportion in an exhaust gas stream of the assembly. In addition, the invention relates to a hydrogen-powered assembly.

Hydrogen-powered assemblies, for example engines, turbines, or fuel cells, convert oxygen and hydrogen into water. There is a chance that unconsummated hydrogen will reach the exhaust gas, for example, due to an ignition failure or incomplete combustion. There is a risk that the unconsummated hydrogen will accumulate in the exhaust gas system and exceed the safety threshold value, which can be, for example, 4%. A mixture consisting of air with a volume proportion of 4% to 76% hydrogen is highly flammable and can lead to an explosion.

Currently, critical hydrogen concentrations in the exhaust gas of a hydrogen-powered assembly can only be detected by way of specific hydrogen sensors. Due to the high exhaust gas temperature of approximately 500° C. downstream of the exhaust gas valve, most commercially available hydrogen sensors, for which the maximum allowable working temperature is typically approximately 100° C., cannot be used in order to directly measure the hydrogen proportion in the exhaust gas. In order to avoid the serious consequences of an explosion within the exhaust gas system or behind the exhaust gas system, other measures are necessary.

### SUMMARY

The problem addressed by the invention is to provide a method and an apparatus for determining a hydrogen proportion in an exhaust gas stream of a hydrogen-powered assembly that avoids the disadvantages of the prior art.

The invention relates to a method for determining a hydrogen proportion in an exhaust gas stream of a hydrogen-powered assembly configured so as to convert hydrogen and oxygen into water. To determine the hydrogen proportion, a balance sheet model is used, which models the conversion of hydrogen and oxygen into water and, using this as a basis, balances hydrogen, oxygen, and water in an input hydrogen stream, an input oxygen stream, and in the exhaust gas stream of the assembly. The method comprises a step of deriving the hydrogen proportion in the exhaust gas stream by means of the balance sheet model from
the input hydrogen stream of the assembly,
the input oxygen stream of the assembly, and
an oxygen proportion in the exhaust gas stream or an exhaust gas lambda value of the exhaust gas stream.

In the method according to the embodiments of the present invention, a balance sheet model is used in order to determine the hydrogen proportion in the exhaust gas stream of the hydrogen-powered assembly, using this as a basis to model the conversion of hydrogen and oxygen into water and calculate a balance of the input streams and output streams of the assembly. Starting from the input hydrogen stream of the assembly, the input oxygen stream of the assembly, as well as the oxygen proportion in the exhaust gas stream or the exhaust gas lambda value of the exhaust gas stream, the hydrogen proportion in the exhaust gas system can be determined by means of the balance sheet model. The hydrogen proportion in the exhaust gas stream determined by means of the balance sheet model can then be compared to a specified threshold value, for example, wherein, if the threshold value is exceeded, suitable reactions are triggered in order to avoid a potential hydrogen explosion. As a result, an effective protection of the system and persons against severe consequences that can result from a hydrogen explosion in the exhaust gas system or in the exhaust gas itself can be achieved.

By using the balance sheet model, the solution according to the invention does not require any specific hydrogen sensor. By means of the balance sheet model, the hydrogen proportion in the exhaust gas stream can be determined without requiring a hydrogen sensor in the exhaust gas stream. Therefore, neither development costs for a new hydrogen sensor nor procurement, installation, and maintenance costs for the hydrogen sensor and its components are incurred.

Additionally, the invention relates to a control unit for a hydrogen-powered assembly. The control unit is configured so as to determine a hydrogen proportion in an exhaust gas stream of the assembly using a balance sheet model, wherein the balance sheet model models the conversion of hydrogen and oxygen into water and uses this as a basis for balancing hydrogen, oxygen, and water in an input hydrogen stream, an input oxygen stream, and in the exhaust gas stream of the assembly. The control unit is configured so as to derive the hydrogen proportion in the exhaust gas stream by means of the balance sheet model from
the input hydrogen stream of the assembly,
the input oxygen stream of the assembly, and
an oxygen proportion in the exhaust gas stream or an exhaust gas lambda value of the exhaust gas stream.

In addition, the invention relates to a hydrogen-powered assembly comprising a control unit as described above.

According to a preferred embodiment, the oxygen proportion in the exhaust gas stream is determined by means of an oxygen sensor.

According to a further preferred embodiment, the exhaust gas lambda value in the exhaust gas stream is determined by means of a lambda sensor.

Preferably, in the balance sheet model, the oxygen proportion in the exhaust gas stream corresponds to the input oxygen stream minus half of the input hydrogen stream multiplied by a degree of conversion η, wherein the degree of conversion η indicates what proportion of the input hydrogen stream is converted into water.

Further preferably, in the balance sheet model, the hydrogen proportion in the exhaust gas stream corresponds to the input hydrogen stream multiplied by (1−η), wherein η denotes a degree of conversion indicating what proportion of the input hydrogen stream is converted into water.

Further preferably, in the balance sheet model, the water proportion in the exhaust gas stream corresponds to the input hydrogen stream multiplied by a degree of conversion η, wherein the degree of conversion η indicates what proportion of the input hydrogen stream is converted into water.

In addition, it is advantageous when, in the balance sheet model, the proportion of other gases in the exhaust gas stream corresponds to an input air stream minus the input oxygen stream.

It is advantageous when the balance sheet model is configured so as to model the temporal dynamics of the input hydrogen stream, the input oxygen stream, and the proportions of the gases in the exhaust gas stream.

Preferably, the method comprises comparing the determined hydrogen proportion in the exhaust gas stream to a specified threshold value and signaling when the hydrogen proportion in the exhaust gas stream exceeds the specified threshold value.

Further preferably, the method comprises comparing the determined hydrogen proportion in the exhaust gas stream to a specified threshold value, and, in the event that the hydrogen proportion in the exhaust gas stream exceeds the specified threshold value, reducing or switching off the input hydrogen stream.

It is advantageous for the hydrogen-powered assembly to comprise at least one of the following:
an air mass sensor for detecting an input air stream;
an input air pressure sensor and an input air temperature sensor for detecting pressure and temperature of the input air stream;
a hydrogen injection device configured so as to supply a specified input hydrogen stream to the assembly;
an oxygen sensor for detecting the oxygen proportion in the exhaust gas stream;
a lambda probe for detecting the exhaust gas lambda value of the exhaust gas stream;
an exhaust gas pressure sensor and an exhaust gas temperature sensor for detecting pressure and temperature of the exhaust gas stream.

Preferably, the hydrogen-powered assembly is one of the following: an engine, a turbine, a fuel cell.

### BRIEF DESCRIPTION OF THE DRAWINGS

Embodiments are explained in greater detail below with reference to the accompanying drawings. Shown are:

FIG. 1 a schematic illustration of a hydrogen-powered assembly;

FIGS. 2A to 2G simulation results of the stationary H₂ model in the range Δ_{Eng} of 1 to 5 for H₂=0% and the H₂ threshold values 2%, 2.5%, 3%, 3.5%, 4%, and 8%;

FIG. 3 a block diagram of a control unit configured so as to determine the hydrogen proportion in the exhaust gas based on an oxygen proportion in the exhaust gas; and

FIG. 4 a block diagram of a control unit configured so as to determine the hydrogen proportion in the exhaust gas based on an exhaust gas lambda value.

### DETAILED DESCRIPTION

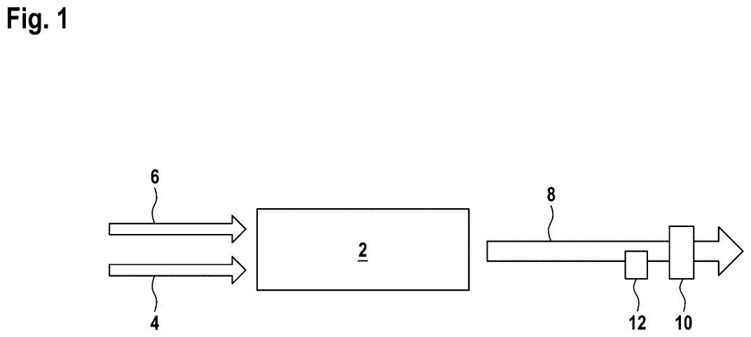

FIG. 1 shows a schematic illustration of a hydrogen-powered assembly 2. The hydrogen-powered assembly 2 is configured so as to convert oxygen and hydrogen into water. For example, the hydrogen-powered assembly 2 can be an engine, a turbine, or a fuel cell. As shown in the example of FIG. 1, an input hydrogen stream 4 and an input air stream 6 are supplied to the hydrogen-powered assembly 2, wherein the input air stream 6 supplied to the hydrogen-powered assembly 2 contains 20.95 vol. % oxygen. In the hydrogen-powered assembly 2, the input hydrogen stream 4 and the input oxygen stream contained in the input air stream 6 are converted into water according to the reaction equation 2H₂+O₂=2H₂O. The exhaust gas stream 8 therefore contains water in a gaseous state. The exhaust gas stream 8 is supplied to an oxidation catalyst 10, which is configured so as to oxidize any hydrogen still contained in the exhaust gas. An oxygen sensor 12 is arranged upstream of the oxidation catalyst 10 and is configured so as to determine the oxygen proportion of the exhaust gas stream 8. Alternatively or additionally, a lambda probe can be arranged upstream of the oxidation catalyst 10 and can be configured so as to detect the exhaust gas lambda value λ_{Exh} in the exhaust gas stream 8.

With the embodiments of the present invention, the goal is to determine the proportion of unconsummated hydrogen in the exhaust gas stream 8 using a balance sheet model that models the conversion of hydrogen and oxygen into water and uses this as a basis for balancing hydrogen, oxygen, and water in the input hydrogen stream, the input oxygen stream, and the exhaust gas stream of the hydrogen-powered assembly. Using such a balance sheet model, the proportion of unconsummated hydrogen in the exhaust gas stream 8 can be determined without the need for a hydrogen sensor. Thus, according to the embodiments of the invention, no specific hydrogen sensor is required in the exhaust gas stream 8. This is particularly advantageous in view of the fact that such a hydrogen sensor would have to be suitable for the high exhaust gas temperature of approximately 500° C. downstream of the exhaust gas valve.

The derivation of the balance sheet model is to be carried out under several assumptions, which are explained in greater detail below.

First, it should be assumed that no condensation water occurs in the exhaust gas stream due to the high exhaust gas temperature in the exhaust gas stream, in particular not on the oxygen sensor or on the lambda sensor in the exhaust gas stream.

Second, it should be assumed that the combustion of the hydrogen occurs stoichiometrically or hyperstoichiometrically, i.e. with excess oxygen or with a lean mixture.

Third, it is to be assumed that the oxygen volume proportion or the lambda value is measured upstream of the oxidation catalyst.

Fourth, it should be assumed that the purity of the hydrogen as a fuel is approximately 100%.

In the following, the formula symbols used for the derivation of the balance sheet model are explained in greater detail. These formula symbols correspond to DIN 1304.

The formula symbol nᵢ denotes the substance amount of the ith species of the gas mixture, wherein this mol is given in mol.

The formula symbol xᵢ denotes the proportion of the substance amount of the ith species of the gas mixture, wherein this substance proportion is given as a dimensionless value.

The formula symbol Vᵢ denotes the volume of the ith species of the gas mixture, wherein this volume is given in dm³ or liters.

The formula symbol Vₘ denotes the molar volume of an ideal gas species, which is 22.4 1/mol under normal conditions.

The formula symbol φᵢ denotes the volume proportion of the ith species of the gas mixture, wherein this volume proportion is given as a dimensionless value.

The formula symbol mᵢ denotes the mass of the ith species of the gas mixture, wherein this mass is given in grams.

The formula symbol Mᵢ denotes the molar mass of the ith species of the gas mixture, wherein this molar mass is given in g/mol.

The formula symbol ωᵢ denotes the mass proportion of the ith species of the gas mixture, wherein this mass proportion is given as a dimensionless value.

The substance amount nᵢ, the volume Vᵢ and the mass mᵢ of the ith species can be related to a unit of time in order to describe molar streams, volumetric flows, or mass currents that are supplied to the assembly per unit of time or discharged from the assembly per unit of time.

### Stationary H₂ Model

First, the air-fuel ratio or target lambda value λ_{Eng} of the hydrogen-powered assembly is to be considered. By definition, the air-fuel ratio indicates the mass ratio of air to fuel relative to the respective stoichiometrically ideal ratio for a theoretically complete combustion process:

$${λ}_{E n g} = \frac{{m}_{Luft}}{{m}_{Luft \vert st \ddot{o} ch}} = \frac{{m}_{Luft} * {ω}_{{O}_{2}}}{{m}_{Luft \vert s t \ddot{o} c h} * {ω}_{{O}_{2}}} = \frac{{m}_{{O}_{2}}}{{m}_{{O}_{2} \vert s t \ddot{o} c h}} = \frac{{M}_{{O}_{2}} ⋆ {n}_{{O}_{2}}}{{M}_{{O}_{2}} ⋆ {n}_{{O}_{2} \vert s t \ddot{o} c h}} = \frac{{n}_{{O}_{2}}}{{n}_{{O}_{2} \vert s t \ddot{o} c h}} \qquad ( 1 )$$

According to the chemical reaction equation O₂+2H₂=2H₂O, the stoichiometric ratio between oxygen and hydrogen is equal to 1:2. Below the stoichiometric combustion ratio, therefore, for 1 mol of hydrogen, 0.5 mol of oxygen is consumed. Thus, n_{O}_{₂}_{|stöch}=0.5*n_{H}_{₂} and equation (1) can be reformulated as follows:

$${λ}_{E n g} = \frac{{n}_{{O}_{2}}}{0 , 5 * {n}_{{H}_{2}}} \qquad ( 2 )$$

The fresh air drawn in contains 20.95 vol. % oxygen. The volume proportion φ_{O}_{₂} of oxygen in the supplied air can therefore be written as:

$${φ}_{{O}_{2}} = \frac{{V}_{{O}_{2}}}{{V}_{Luft}} = \frac{{V}_{{O}_{2}} / {V}_{m}}{{V}_{Luft} / {V}_{m}} = \frac{{n}_{{O}_{2}}}{{n}_{Luft}} = 0.2095 \qquad ( 3 )$$

The degree of conversion η indicates what proportion of the supplied input hydrogen is converted into water. If η denotes the degree of conversion of the supplied input hydrogen, then η*n_{H}_{₂}, describes the substance amount of the combusted hydrogen, while (1−η)*n_{H}_{₂} describes the substance amount of the unconsumed hydrogen.

According to the chemical reaction equation O₂+2H₂=2H₂O, the conversion of η*N_{H}_{₂} requires 0.5 times the amount of oxygen. The amount of oxygen n_{O}_{₂}_{_Exh} in the exhaust gas stream is then derived from the intake amount and the deducted amount of oxygen consumption:

$${n}_{{O}_{2} \_ Exh} = {n}_{{O}_{2}} - 0 , 5 * η * {n}_{{H}_{2}} \qquad ( 4 )$$

The amount of hydrogen n_{H}_{₂}_{_Exh} in the exhaust gas stream is the amount of the remaining unconsummated hydrogen:

$${n}_{{H}_{2} \_ Exh} = ( 1 - η ) * {n}_{{H}_{2}} \qquad ( 5 )$$

The water in the exhaust gas stream is created by the combustion of the hydrogen. According to the above reaction equation for H₂ combustion, the amount of water produced precisely corresponds to the amount of hydrogen combusted:

$${n}_{{H}_{2} O\_Exh} = η * {n}_{{H}_{2}} \qquad ( 6 )$$

In addition, the exhaust gas stream contains the other gas species not participating in the H₂ combustion, for example nitrogen. These gas species pass unchanged from the intake side via the combustion chamber into the exhaust gas stream. Nitrogen can indeed react with oxygen in the combustion chamber in some circumstances in order to produce NOₓ. However, this is neglected in the present consideration, because the NOₓ amount is marginal compared to the unconsummated hydrogen to be calculated. for the amount of other gases n_{Rest_Exh} in the exhaust gas stream, the following results:

$${n}_{Rest\_Exh} = {n}_{Luft} - {n}_{{O}_{2}} \qquad ( 7 )$$

By employing equation (3) in equation (7), the following results:

$${n}_{Rest\_Exh} = \frac{{n}_{{O}_{2}}}{{φ}_{{O}_{2}}} - {n}_{{O}_{2}} \qquad ( 8 )$$

The above equations (4), (5), (6), (8) indicate the amount of oxygen, hydrogen, water, and other gas species in the exhaust gas stream. The substance proportion x_{O}_{₂}_{_Exh} of oxygen in the exhaust gas stream can be calculated therefrom:

$${x}_{{O}_{2} \_ Exh} = \frac{{n}_{{O}_{2} \_ Exh}}{{n}_{E x h}} = \frac{{n}_{{O}_{2} \_ Exh}}{{n}_{{O}_{2} \_ Exh} + {n}_{{H}_{2} \_ Exh} + {n}_{{H}_{2} O \_ Exh} + {n}_{Rest\_Exh}} \qquad ( 9 )$$

$${x}_{{O}_{2} \_ Exh} = \frac{{n}_{{O}_{2}} - 0 , 5 * η * {n}_{{H}_{2}}}{{n}_{{O}_{2}} - 0 , 5 * η * {n}_{{H}_{2}} + ( 1 - η ) * {n}_{{H}_{2}} + η * {n}_{{H}_{2}} + \frac{{n}_{{O}_{2}}}{{φ}_{{O}_{2}}} - {n}_{{O}_{2}}}$$

$${x}_{{O}_{2} \_ Exh} = \frac{{n}_{{O}_{2}} - 0 , 5 * η * {n}_{{H}_{2}}}{\frac{{n}_{{O}_{2}}}{{φ}_{{O}_{2}}} + ( 1 - 0 , 5 ⋆ η ) ⋆ {n}_{{H}_{2}}}$$

Similarly, the substance proportion x_{H}_{₂}_{_Exh} of hydrogen in the exhaust gas stream can be formulated as:

$${x}_{{H}_{2} \_ Exh} = \frac{{n}_{{H}_{2} \_ Exh}}{{n}_{E x h}} = \frac{{n}_{{H}_{2} \_ Exh}}{{n}_{{O}_{2} \_ Exh} + {n}_{{H}_{2} \_ Exh} + {n}_{{H}_{2} O \_ Exh} + {n}_{Rest \_ Exh}} \qquad ( 10 )$$

$${x}_{{H}_{2} \_ Exh} = \frac{( 1 - η ) * {n}_{{H}_{2}}}{\frac{{n}_{{O}_{2}}}{{φ}_{{O}_{2}}} + ( 1 - 0 , 5 ⋆ η ) ⋆ {n}_{{H}_{2}}}$$

If equation (9) is divided by equation (10), the result is:

$$\frac{{n}_{{O}_{2} \_ Exh}}{{x}_{{H}_{2} \_ Exh}} = \frac{{n}_{{O}_{2}} - 0 , 5 * η * {n}_{{H}_{2}}}{( 1 - η ) * {n}_{{H}_{2}}} \qquad ( 11 )$$

Then, equation (11) is solved according to the degree of conversion and the result is:

$$η = \frac{{x}_{{O}_{2} \_ Exh} - \frac{{n}_{{O}_{2}}}{{n}_{{H}_{2}}} * {x}_{{H}_{2} \_ Exh}}{{x}_{{O}_{2} \_ Exh} - 0.5 * {x}_{{H}_{2} \_ Exh}} \qquad ( 12 )$$

If this expression is used for the degree of conversion η in equation (10), the following is obtained for the substance proportionx_{H}_{₂}_{_Exh}:

$${x}_{{H}_{2} \_ Exh} = \frac{( 1 - \frac{{x}_{{O}_{2} \_ Exh} - \frac{{n}_{{O}_{2}}}{{n}_{{H}_{2}}} * {x}_{{H}_{2} \_ Exh}}{{x}_{{O}_{2} \_ Exh} - 0.5 * {x}_{{H}_{2} \_ Exh}} ) * {n}_{{H}_{2}}}{\frac{{n}_{{O}_{2}}}{{φ}_{{O}_{2}}} + ( 1 - 0.5 * \frac{{x}_{{O}_{2} \_ Exh} - \frac{{n}_{{O}_{2}}}{{n}_{{H}_{2}}} * {x}_{{H}_{2} \_ Exh}}{{x}_{{O}_{2} \_ Exh} - 0.5 * {x}_{{H}_{2} \_ Exh}} ) * {n}_{{H}_{2}}} \qquad ( 13 )$$

On the right side of the equation, the numerators and denominators are each divided by n_{H}_{₂}, and the calculation proceeds:

$${x}_{{H}_{2} \_ Exh} = \frac{1 - \frac{{x}_{{O}_{2} \_ Exh} - \frac{{n}_{{O}_{2}}}{{n}_{{H}_{2}}} * {x}_{{H}_{2} \_ Exh}}{{x}_{{O}_{2} \_ Exh} - 0.5 * {x}_{{H}_{2} \_ Exh}}}{\frac{{n}_{{O}_{2}}}{{n}_{{H}_{2}}} * \frac{1}{{φ}_{{O}_{2}}} + ( 1 - 0.5 * \frac{{x}_{{O}_{2} \_ Exh} - \frac{{n}_{{O}_{2}}}{{n}_{{H}_{2}}} * {x}_{{H}_{2} \_ Exh}}{{x}_{{O}_{2} \_ Exh} - 0.5 * {x}_{{H}_{2} \_ Exh}} )} \qquad ( 14 )$$

If

$$\frac{{n}_{{O}_{2}}}{{n}_{{H}_{2}}} = 0.5 * {λ}_{Eng}$$

is employed in equation (14) according to equation (2), then:

$${x}_{{H}_{2} \_ Exh} = \frac{1 - \frac{{x}_{{O}_{2} \_ Exh} - 0.5 * {λ}_{Eng} * {x}_{{H}_{2} \_ Exh}}{{x}_{{O}_{2} \_ Exh} - 0.5 * {x}_{{H}_{2} \_ Exh}}}{0.5 * {λ}_{Eng} * \frac{1}{{φ}_{{O}_{2}}} + ( 1 - 0.5 * \frac{{x}_{{O}_{2} \_ Exh} - 0.5 * {λ}_{Eng} * {x}_{{H}_{2} \_ Exh}}{{x}_{{O}_{2} \_ Exh} - 0.5 * {x}_{{H}_{2} \_ Exh}} )} \qquad ( 15 )$$

Now equation (15) is solved according to x_{H}_{₂}_{_Exh}, and the result is:

$${x}_{{H}_{2} \_ Exh} = \frac{{x}_{{O}_{2} \_ Exh} * ( \frac{1}{{φ}_{{O}_{2}}} * {λ}_{Eng} + 1 ) - ( {λ}_{Eng} - 1 )}{1 + ( 0.5 * \frac{1}{{φ}_{{O}_{2}}} - 0.5 ) * {λ}_{Eng}} \qquad ( 16 )$$

According to equation (3), φ_{O}_{₂}=0.2095. If φ_{O}_{₂}=0.2095 is used in equation (16), then for x_{H}_{₂}_{_Exh}, the following is obtained:

$${x}_{{H}_{2} \_ Exh} = \frac{{x}_{{O}_{2} \_ Exh} * ( 4.7733 * {λ}_{E n g} + 1 ) - ( {λ}_{E n g} - 1 )}{1 + 1.8866 * {λ}_{E n g}} \qquad ( 17 )$$

Equation (17) is the computational representation of the H₂ model. The hydrogen proportion x_{H}_{₂}_{_Exh} is expressed by the lambda value λ_{Eng} of the gas mixture and by the oxygen proportion x_{O}_{₂}_{_Exh} in the exhaust gas stream.

In the following, the oxygen proportion x_{O}_{₂}_{_Exh} in the exhaust gas stream is to be expressed by the exhaust gas lambda λ_{Exh} in the exhaust gas stream. When the H₂ combustion is complete, then λ_{Exh} in the exhaust gas is measured the same as λ_{Eng}, the lambda value of the gas mixture prior to combustion. If η=1, φ_{O}_{₂}=0.2095 and

$$\frac{{n}_{{O}_{2}}}{{n}_{{H}_{2}}} = 0.5 * {λ}_{Eng}$$

is employed in equation (9), the following is obtained:

$${x}_{{O}_{2} \_ Exh} = \frac{{n}_{{O}_{2}} - 0.5 * {n}_{{H}_{2}}}{\frac{{n}_{{O}_{2}}}{{φ}_{{O}_{2}}} + 0.5 * {n}_{{H}_{2}}} = \frac{\frac{{n}_{{O}_{2}}}{{n}_{{H}_{2}}} - 0.5}{\frac{{n}_{{O}_{2}}}{{n}_{{H}_{2}}} * \frac{1}{{φ}_{{O}_{2}}} + 0.5} = \frac{0.5 * {λ}_{E n g} - 0.5}{0.5 * {λ}_{E n g} * \frac{1}{{φ}_{{O}_{2}}} + 0.5} = \frac{{λ}_{E n g} - 1}{4.7733 * {λ}_{E n g} + 1} i . \qquad ( 18 )$$

If λ_{Eng} is replaced with λ_{Exh}, then equation (18) gives:

$${x}_{{O}_{2} \_ Exh} = \frac{{λ}_{Exh} - 1}{4.7733 * {λ}_{Exh} + 1} \qquad ( 19 )$$

Equation (19) can be solved according to λ_{Exh}. In this manner, the result is:

$${λ}_{Exh} = \frac{1 + {x}_{{O}_{2} \_ Exh}}{1 - 4.7733 * {x}_{{O}_{2} \_ Exh}} \qquad ( 20 )$$

With equation (20), x_{O}_{₂}_{_Exh} can be converted according to λ_{Exh}. If equation (19) is employed in equation (17), the result is:

$${x}_{{H}_{2} \_ Exh} = \frac{\frac{1 + 4.7733 * {λ}_{Eng}}{1 + 4.7733 * {λ}_{Exh}} * ( {λ}_{Exh} - 1 ) - ( {λ}_{Eng} - 1 )}{1 + 1.8866 * {λ}_{Eng}} \qquad ( 21 )$$

Equation (21) is a further computational representation of the H₂ model. Here, the hydrogen proportion x_{H}_{₂}_{_Exh} is expressed by the lambda value λ_{Eng} of the gas mixture before combustion and by the exhaust gas lambda value λ_{Exh} in the exhaust gas stream.

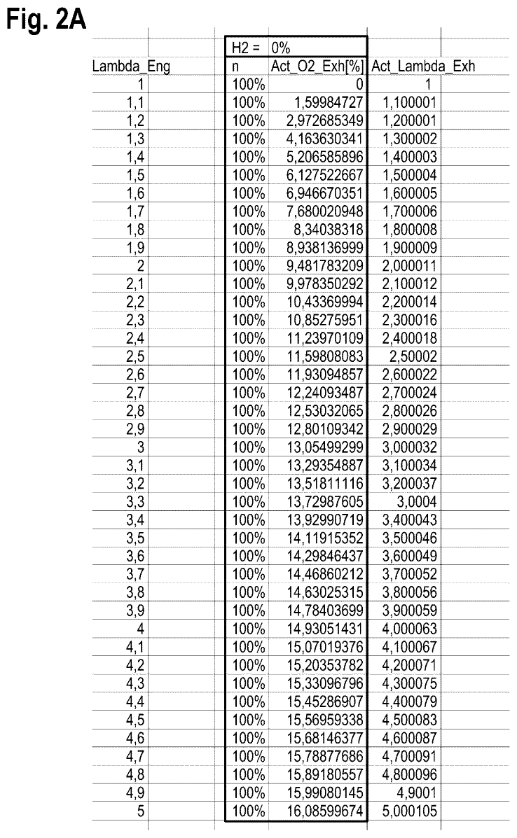

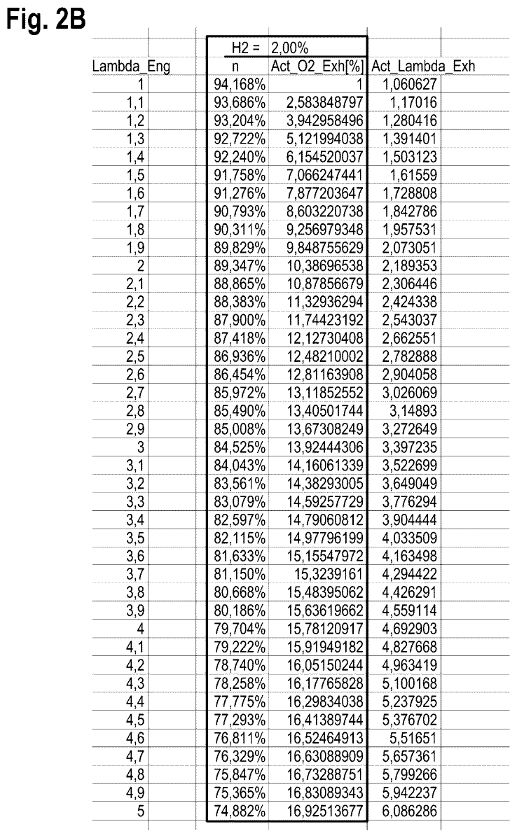

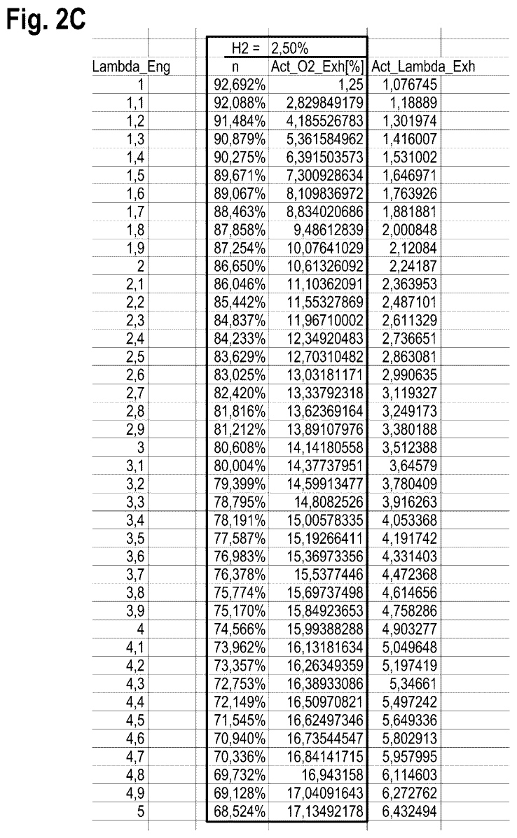

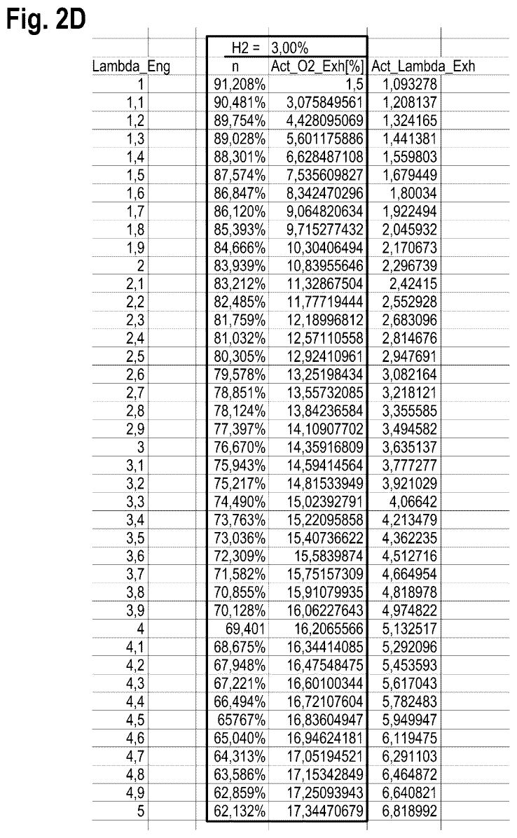

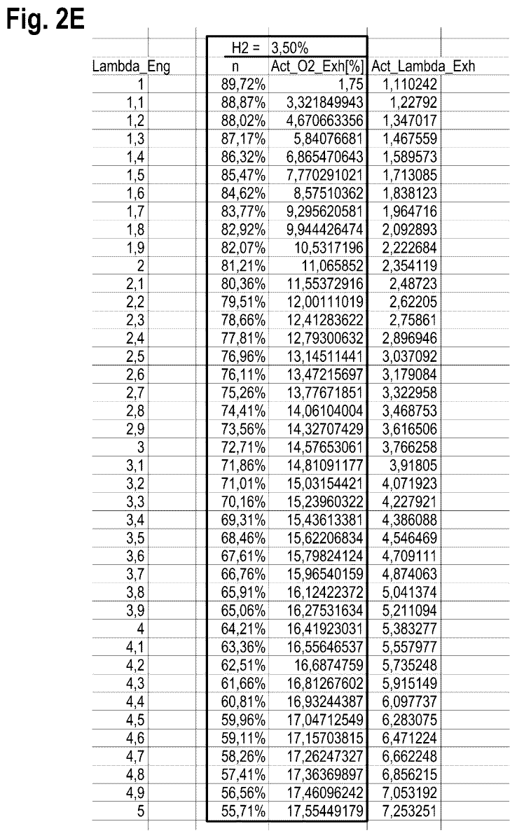

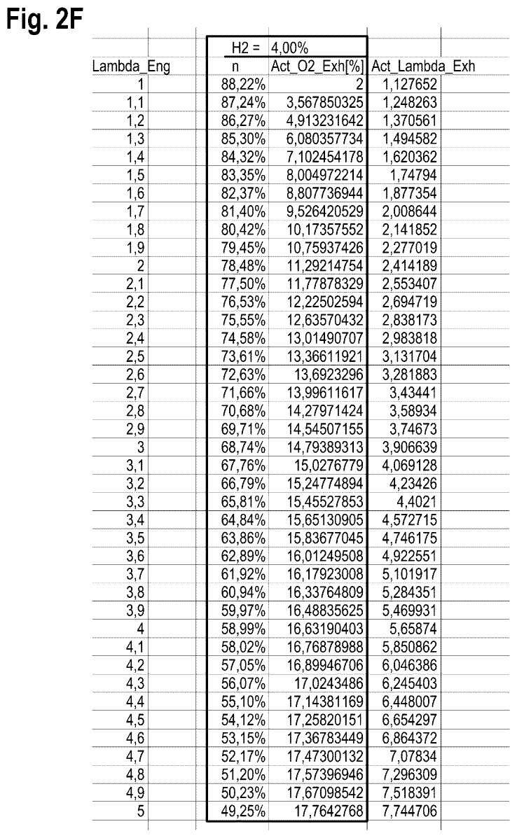

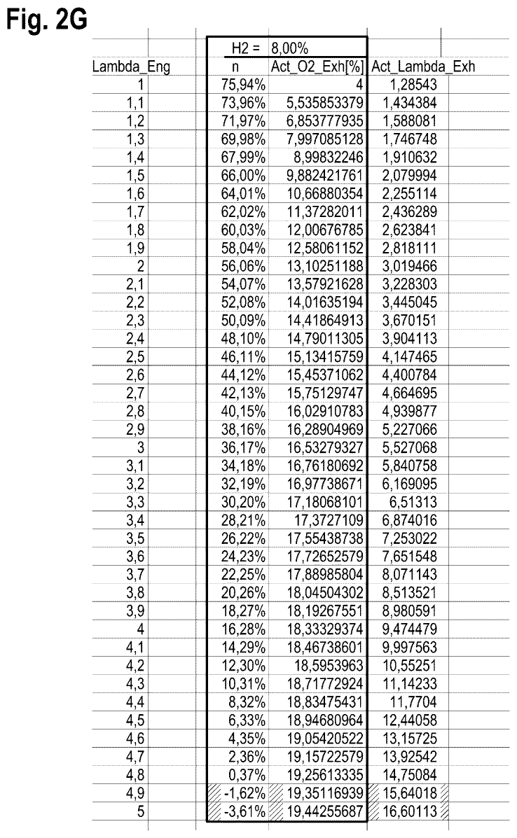

FIGS. 2A to 2G show simulation results for the H₂ model described above, namely for the range of the lambda value λ_{Eng} from 1 to 5 with the computing step 0.1. The oxygen proportion x_{O}_{₂}_{_Exh}, expressed herein by the variable Act_O2_Exh, and the exhaust gas lambda value λ_{Exh}, expressed herein by the variable Act_Lambda_Exh, was calculated for the H₂ value 0% and for the typical H₂ threshold values 2%, 2.5%, 3%, 3.5%, 4%, and 8%.

Dynamic H₂ model

The hydrogen proportion x_{H}_{₂}_{_Exh} in the exhaust gas stream, the oxygen proportion x_{O}_{₂}_{_Exh} in the exhaust gas stream, and the lambda value λ_{Eng} of the gas mixture all have a temporal dependency in the real world. Thus, equation (17) can be described in an abstractive manner as the following function:

$${x}_{{H}_{2} \_ Exh} ( t ) = f ( {x}_{{O}_{2} \_ Exh} ( t ) , {λ}_{Eng} ( t ) ) \qquad ( 22 )$$

If equation (22) is derived according to time, the result is:

$$\frac{{dx}_{{H}_{2} \_ Exh}}{dt} = \frac{\partial f}{\partial {x}_{{O}_{2} \_ Exh}} \frac{{dx}_{{O}_{2} \_ Exh}}{dt} + \frac{\partial f}{\partial {λ}_{Eng}} \frac{d {λ}_{Eng}}{dt} \qquad ( 23 )$$

$$\frac{{dx}_{{H}_{2} \_ Exh}}{dt} = \frac{1 + 4.7733 * {λ}_{Eng}}{1 + 1.8866 * {λ}_{Eng}} \frac{{dx}_{{O}_{2} \_ Exh}}{dt} + \frac{2.8866 * ( {x}_{{O}_{2} \_ Exh} - 1 )}{{( 1 + 1.8866 * {λ}_{Eng} )}^{2}} \frac{d {λ}_{Eng}}{dt} \qquad ( 24 )$$

In this way, the temporal dependency of the hydrogen proportion x_{H}_{₂}_{_Exh} in the exhaust gas stream is related to the temporal dependency of the oxygen proportion x_{O}_{₂}_{_Exh} in the exhaust gas stream and the lambda value of λ_{Eng} the gas mixture.

Using the same derivation process, equation (21) can be rewritten into a differential equation according to time:

$$\frac{{dx}_{{H}_{{2}_{Exh}}}}{dt} = \frac{5.7733 * ( 1 + 4.7733 * {λ}_{Eng} )}{( 1 + 1.8866 * {λ}_{Eng} ) * {( 1 + 4.7733 * {λ}_{Exh} )}^{2}} * \frac{d {λ}_{Exh}}{dt} -- \frac{5.7733 * ( 1 + 1.8866 * {λ}_{Exh} )}{( 1 + 4.7733 * {λ}_{Exh} ) * {( 1 + 1.8866 * {λ}_{Eng} )}^{2}} \frac{d {λ}_{Eng}}{dt} \qquad ( 25 )$$

In this way, the temporal dependency of the hydrogen proportion x_{H}_{₂}_{_Exh} in the exhaust gas stream is related to the temporal dependency of the exhaust gas lambda value λ_{Exh} and the lambda value λ_{Eng} of the gas mixture.

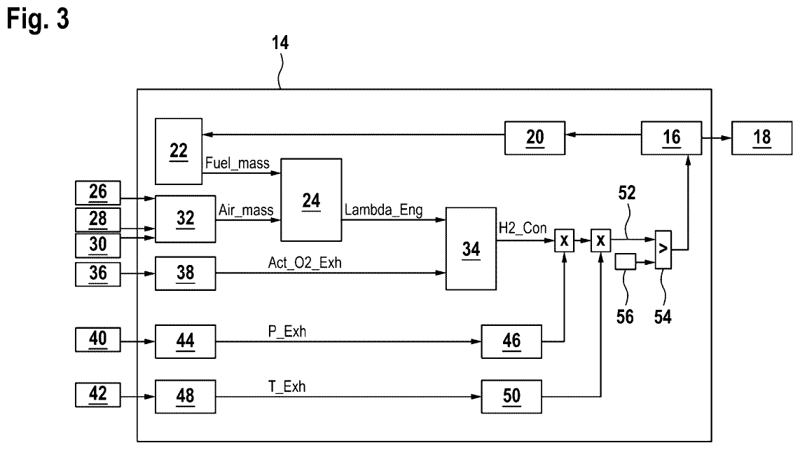

In FIG. 3, as an example, a control unit 14 for a hydrogen assembly is shown in the form of a block diagram. The control unit 14 is configured, among other things, so as to monitor the input air stream and the input water stream of the hydrogen assembly. The control unit 14 comprises an injection control 16 configured so as to generate control signals for the H₂ injector 18 of the hydrogen assembly. The control unit 14 is configured in particular so as to monitor that the hydrogen proportion in the exhaust gas remains below a specified threshold value. For this purpose, the injection parameters used by the injection control 16, in particular the injection duration and angle, are returned via a device 20 for feeding the injection parameters back to a device 22 for the injection quantity determination. The device 22 for injector quantity determination is configured so as to determine a fuel mass stream Fuel_mass and to transmit this value Fuel_mass to a device 24 for lambda value determination. The device 24 for lambda value determination is configured so as to determine the lambda value λ_{Eng} of the gas mixture prior to combustion, expressed here by the variable Lambda_Eng. To determine the lambda value Lambda_Eng, the input air stream of the hydrogen assembly is also required. For this purpose, an air mass sensor 26 is connected to the control unit 14. In addition, an input air pressure sensor 28 and an input air temperature sensor 30 are connected to the control unit 14. The sensor signals of these sensors are evaluated by the device 32 for air mass stream determination, and the thusly determined air mass stream Air_mass is transmitted to the device 24 for lambda value determination. Based on the fuel mass stream Fuel_mass and the air mass stream Air_mass, the device 24 for lambda value determination determines the lambda value Lambda_Eng of the gas mixture prior to combustion. The lambda value Lambda_Eng of the gas mixture prior to combustion is provided to a balancing device 34.

Furthermore, an oxygen sensor 36 for detecting the oxygen proportion in the exhaust gas stream is connected to the control unit 14. A device 38 for oxygen proportion determination in the exhaust gas stream is configured so as to read the oxygen sensor 36 and provide the current oxygen proportion x_{O}_{₂}_{_Exh} in the exhaust gas stream to the balancing device 34, expressed here by the variable Act_O2_Exh.

The balancing device 34 is configured so as to determine the hydrogen proportion in the exhaust gas stream based on a balance sheet model of the gas streams. In particular, the balancing device 34 is configured so as to determine the hydrogen proportion H2_Con in the exhaust gas stream starting from the lambda value Lambda_Eng and the oxygen proportion Act_O2_Exh in the exhaust gas stream and based on the balance sheet model.

However, the hydrogen proportion H2_Con supplied by the balancing device 34 must be converted to the current pressure and temperature conditions in the exhaust gas stream before its evaluation. For this purpose, an exhaust gas pressure sensor 40 and an exhaust gas temperature sensor 42 are connected to the control unit 14. The control unit 14 comprises a device 44 for exhaust gas pressure determination, which is configured so as to determine the exhaust gas pressure P_Exh starting from the sensor value of the exhaust gas pressure sensor 40, as well as a first signal conversion unit 46 that converts the exhaust gas pressure P_Exh into a correction value for correcting the hydrogen proportion H2_Con. Furthermore, the control unit 14 comprises a device 48 for exhaust gas temperature determination configured so as to determine the exhaust gas pressure T_Exh starting from the sensor value of exhaust gas temperature sensor 42, as well as a second signal conversion unit 50 that converts exhaust gas temperature T_Exh into a correction value for correcting the hydrogen proportion H2_Con.

The corrected hydrogen proportion 52 thus obtained is compared in the comparison device 54 to a safety threshold value 56, for example a safety threshold value 56 of 4% hydrogen proportion. If, in this comparison, it is determined that the corrected hydrogen proportion 52 is above the safety threshold value 56, then this exceeding of the threshold value is signaled. In addition, suitable measures can be taken, for example, to reduce the too high proportion of hydrogen in the exhaust gas stream. In the example shown in FIG. 3, in this case, the comparison device 54 acts on the injection control 16 and switches off the hydrogen supply to the H₂ injector 18.

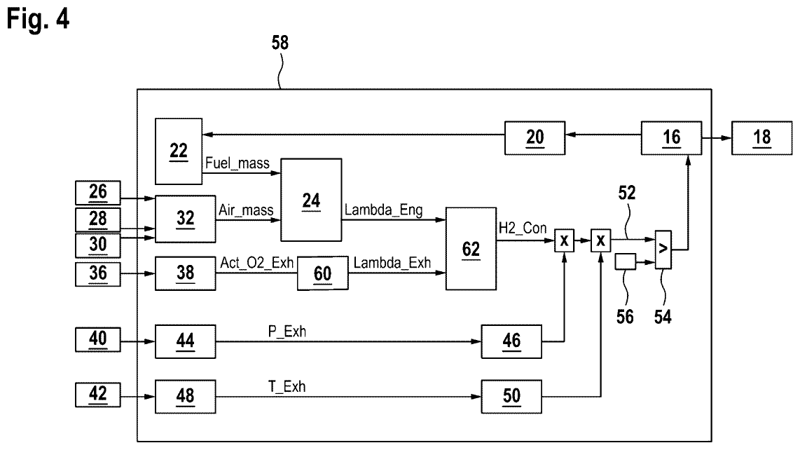

In the balancing device 34 shown in FIG. 3, the lambda value Lambda_Eng of the gas mixture prior to combustion and the oxygen proportion Act_O2_Exh of the exhaust gas stream were used as a starting point for determining the hydrogen proportion in the exhaust gas stream by means of the balance sheet model. FIG. 4 shows an alternative embodiment of a control unit 58, wherein the differences between the two embodiments are discussed in greater detail below. In particular, the control unit 58 comprises a device 60 for exhaust gas lambda value determination, which is configured so as to convert the oxygen proportion Act_O2_Exh in the exhaust gas stream into an exhaust gas lambda value λ_{Exh} in the exhaust gas stream, expressed here by the variable Lambda_Exh. This exhaust gas lambda value Lambda_Exh is then supplied to the balancing device 62. In the embodiment shown in FIG. 4, the balancing device 62 is configured so as to determine, by means of the balance sheet model, the hydrogen proportion H2_Con in the exhaust gas stream starting from the lambda value Lambda_Eng of the gas mixture prior to combustion and the exhaust gas lambda value Lambda_Exh value in the exhaust gas stream. Thus, unlike in the embodiment shown in FIG. 3, in FIG. 4 the exhaust gas lambda value Lambda_Exh in the exhaust gas stream is used as the starting point for determining the hydrogen proportion H2_Con. All other components of the control unit 58 shown in FIG. 4 match the components of control unit 14 shown in FIG. 3 and have the same reference numerals as in FIG. 3.

The features disclosed in the foregoing description, claims and drawings may be of importance, both individually and in any combination, for the realization of the invention in its various embodiments.

1. A computer-implemented method for determining a hydrogen proportion in an exhaust gas stream (8) of a hydrogen-powered assembly (2) configured to convert hydrogen and oxygen into water, wherein a balance sheet model is used in order to determine the hydrogen proportion by modeling the conversion of hydrogen and oxygen into water and using this as a basis for balancing hydrogen, oxygen, and water in an input hydrogen stream (4), an input oxygen stream, and in the exhaust gas stream (8) of the assembly (2), wherein the method comprises:
deriving the hydrogen proportion in the exhaust gas stream (8) via the balance sheet model from
the input hydrogen stream (4) of the assembly (2),
the input oxygen stream of the assembly (2), and
an oxygen proportion in the exhaust gas stream (8) or an exhaust gas lambda value of the exhaust gas stream (8).

2. The method according to claim 1, wherein the oxygen proportion in the exhaust gas stream (8) is determined by means of an oxygen sensor (12, 36).

3. The method according to claim 1, wherein the exhaust gas lambda value in the exhaust gas stream (8) is determined by means of a lambda sensor.

4. The method according to claim 1, wherein, in the balance sheet model, the oxygen proportion in the exhaust gas stream (8) corresponds to the input oxygen stream minus half of the input hydrogen stream (4) multiplied by a degree of conversion η, wherein the degree of conversion η indicates what proportion of the input hydrogen stream (4) is converted into water.

5. The method according to claim 1, wherein, in the balance sheet model, the hydrogen proportion in the exhaust gas stream (8) corresponds to the input hydrogen stream (4) multiplied by (1−η), wherein η denotes a degree of conversion indicating what proportion of the input hydrogen stream (4) is converted into water.

6. The method according to claim 1, wherein, in the balance sheet model, the water proportion in the exhaust gas stream (8) corresponds to the input hydrogen stream (4) multiplied by a degree of conversion η, wherein the degree of conversion η indicates what proportion of the input hydrogen stream (4) is converted into water.

7. The method according to claim 1, wherein, in the balance sheet model, the proportion of other gases in the exhaust gas stream (8) corresponds to an input air stream (6) minus the input oxygen stream.

8. The method according to claim 1, wherein the balance sheet model is configured to model the temporal dynamics of the input hydrogen stream (4), the input oxygen stream, and the proportions of the gases in the exhaust gas stream (8).

9. The method according to claim 1, wherein the method further comprises:
comparing the determined hydrogen proportion in the exhaust gas stream (8) to a specified threshold value (56), and
signaling when the hydrogen proportion in the exhaust gas stream (8) exceeds the specified threshold value (56).

10. The method according to claim 1, wherein the method further comprises:
comparing the determined hydrogen proportion in the exhaust gas stream (8) to a specified threshold value (56), and
in the event that the hydrogen proportion in the exhaust gas stream (8) exceeds the specified threshold value (56), reducing or switching off the input hydrogen stream (4).

11. A control unit (14, 58) for a hydrogen-powered assembly (2), wherein the control unit (14, 58) is configured to determine a hydrogen proportion in an exhaust gas stream (8) of the assembly (2) using a balance sheet model, wherein the balance sheet model models the conversion of hydrogen and oxygen into water and uses this as a basis for balancing hydrogen, oxygen, and water in an input hydrogen stream (4), an input oxygen stream, and in the exhaust gas stream (8) of the assembly (2), wherein the control unit (14, 58) is configured to derive the hydrogen proportion in the exhaust gas stream (8) via the balance sheet model from
the input hydrogen stream (4) of the assembly (2),
the input oxygen stream of the assembly (2), and
an oxygen proportion in the exhaust gas stream (8) or an exhaust gas lambda value of the exhaust gas stream (8).

12. A hydrogen-powered engine, turbine, or fuel cell comprising a control unit (14, 58) according to claim 11.

13. A hydrogen-powered assembly (2) according to claim 12, wherein the hydrogen-powered assembly (2) comprises:
an air mass sensor (26) for detecting an input air stream (6);
an input air pressure sensor (28) and an input air temperature sensor (30) for detecting pressure and temperature of the input air stream (6);
a hydrogen injection device (18) configured to supply a specified input hydrogen stream (4) to the assembly (2);
an oxygen sensor (12, 36) for detecting the oxygen proportion in the exhaust gas stream (8);
a lambda probe for detecting the exhaust gas lambda value of the exhaust gas stream (8); and
an exhaust gas pressure sensor (40) and an exhaust gas temperature sensor (42) for detecting pressure and temperature of the exhaust gas stream (8).

14. A non-transitory, computer-readable medium comprising instructions that, when executed by a computer, prompt the latter to determine a hydrogen proportion in an exhaust gas stream (8) of a hydrogen-powered assembly (2) configured to convert hydrogen and oxygen into water, wherein a balance sheet model is used to determine the hydrogen proportion by modeling the conversion of hydrogen and oxygen into water and using this as a basis for balancing hydrogen, oxygen, and water in an input hydrogen stream (4), an input oxygen stream, and in the exhaust gas stream (8) of the assembly (2), by:
deriving the hydrogen proportion in the exhaust gas stream (8) via the balance sheet model from
the input hydrogen stream (4) of the assembly (2),
the input oxygen stream of the assembly (2), and
an oxygen proportion in the exhaust gas stream (8) or an exhaust gas lambda value of the exhaust gas stream (8).
